(19) United States
(12) Patent Application Publication
(10) Pub. No.: US 2025/0247743 A1
(43) Pub. Date: Jul. 31, 2025

(54) SYSTEMS AND METHODS FOR MULTI-MODAL SIGNALING

(71) Applicant: Meta Platforms Technologies, LLC, Menlo Park, CA (US)

(72) Inventors: Liwen Yu, Santa Clara, CA (US); Curt Wong, Bellevue, WA (US); Zhu Ji, Cupertino, CA (US)

(73) Assignee: Meta Platforms Technologies, LLC, Menlo Park, CA (US)

(21) Appl. No.: 19/015,596

(22) Filed: Jan. 9, 2025

Related U.S. Application Data
(60) Provisional application No. 63/627,420, filed on Jan. 31, 2024.

(51) Int. Cl. H04W 28/10; H04W 28/02

(52) U.S. Cl. CPC H04W 28/10; H04W 28/0268

(57) ABSTRACT

Systems and methods for multi-modal signaling may include a first device which identifies a plurality of modalities relating to respective traffic types of a multi-modal flow of an application, for traffic of the application to be sent to a second device. The first device may generate a first tag for a first service data flow (SDF) for a first modality and a second tag for a second SDF for a second modality. The first tag and the second tag may indicate an association between the first SDF and the second SDF within the multi-modal flow. The first device may transmit, via a transmitter to a wireless communication node, one or more signals indicating the first tag and the second tag, for transmission of the traffic between the first device and the second device.

### CROSS-REFERENCE TO RELATED APPLICATIONS

This application claims the benefit of and priority to U.S. Provisional Application No. 63/627,420, filed Jan. 31, 2024, the contents of which are incorporated herein by reference in their entirety.

### FIELD OF DISCLOSURE

The present disclosure is generally related to wireless communication between devices, including but not limited to, systems and methods for multi-modal signaling.

### BACKGROUND

Augmented reality (AR), virtual reality (VR), and mixed reality (MR) are becoming more prevalent, which such technology being supported across a wider variety of platforms and device. Some devices may be supported through cellular communications.

### SUMMARY

In one aspect, this disclosure relates to a method, including identifying, by a first device, a plurality of modalities relating to respective traffic types of a multi-modal flow of an application, for traffic of the application to be sent to a second device. The method may include generating, by the first device, a first tag for a first service data flow (SDF) for a first modality and a second tag for a second SDF for a second modality, the first tag and the second tag indicating an association between the first SDF and the second SDF within the multi-modal flow. The method may include transmitting, by the first device to a wireless communication node, one or more signals indicating the first tag and the second tag, for transmission of the traffic between the first device and the second device.

In some embodiments, the plurality of modalities includes at least one of an audio modality, a video modality, a voice modality, a sensor modality, a control modality, or a file transfer protocol (FTP) modality. In some embodiments, each modality is associated with a respective SDF, and each SDF is mapped to a respective quality of service (QoS) flow. In some embodiments, the first SDF is mapped to a first QoS flow, and the second SDF is mapped to the first QoS flow. In some embodiments, the first tag is applied to a first portion of traffic associated with the first modality on the first QoS flow, and the second tag is applied to a second portion of traffic associated with the second modality on the first QoS flow. In some embodiments, a third SDF for a third modality of the plurality of modalities is mapped to a second QoS flow.

In some embodiments, the first device identifies the plurality of modalities based on the application executing on the first device. In some embodiments, transmitting the first tag and the second tag, causes the wireless communication node to coordinate a first portion of traffic of the first SDF and a second portion of traffic corresponding of the second SDF, for transmission to the second device, according to the first tag and the second tag. In some embodiments, the method includes generating, by the first device, for each modality of the plurality of modalities, a respective indicator indicating a relative quality of service (QoS) metric for the modality relative to other of the plurality of modalities.

In another aspect, this disclosure is directed to a first device including one or more processors configured to identify a plurality of modalities relating to respective traffic types of a multi-modal flow of an application, for traffic of the application to be sent to a second device. The one or more processors may be configured to generate a first tag for a first service data flow (SDF) for a first modality and a second tag for a second SDF for a second modality, the first tag and the second tag indicating an association between the first SDF and the second SDF within the multi-modal flow. The one or more processors may be configured to transmit, via a transmitter to a wireless communication node, one or more signals indicating the first tag and the second tag, for transmission of the traffic between the first device and the second device.

In some embodiments, the plurality of modalities include at least one of an audio modality, a video modality, a voice modality, a sensor modality, a control modality, or a file transfer protocol (FTP) modality. In some embodiments, each modality is associated with a respective SDF, and wherein each SDF is mapped to a respective quality of service (QoS) flow. In some embodiments, the first SDF is mapped to a first QoS flow, and the second SDF is mapped to the first QoS flow. In some embodiments, the first tag is applied to a first portion of traffic associated with the first modality on the first QoS flow, and the second tag is applied to a second portion of traffic associated with the second modality on the first QoS flow. In some embodiments, a third SDF for a third modality of the plurality of modalities is mapped to a second QoS flow.

In some embodiments, the first device identifies the plurality of modalities based on the application executing on the first device. In some embodiments, transmission of the first tag and the second tag, causes the wireless communication node to coordinate a first portion of traffic of the first SDF and a second portion of traffic corresponding of the second SDF, for transmission to the second device, according to the first tag and the second tag. In some embodiments, the one or more processors are configured to generate, by the first device, for each modality of the plurality of modalities, a respective indicator indicating a relative quality of service (QoS) metric for the modality relative to other of the plurality of modalities.

In yet another aspect, this disclosure is directed to a non-transitory computer readable medium storing instructions that, when executed by one or more processors, cause the one or more processors to identify a plurality of modalities relating to respective traffic types of a multi-modal flow of an application, for traffic of the application to be sent to a second device. The instructions may further cause the one or more processors to generate a first tag for a first service data flow (SDF) for a first modality and a second tag for a second SDF for a second modality, the first tag and the second tag indicating an association between the first SDF and the second SDF within the multi-modal flow. The instructions may further cause the one or more processors to transmit, via a transmitter to a wireless communication node, one or more signals indicating the first tag and the second tag, for transmission of the traffic between the first device and the second device.

In some embodiments, each modality is associated with a respective SDF, and wherein each SDF is mapped to a respective quality of service (QoS) flow, including the first SDF and the second SFC being mapped to a first QoS flow, and a third modality being mapped to a second QoS flow.

### BRIEF DESCRIPTION OF THE DRAWINGS

The accompanying drawings are not intended to be drawn to scale. Like reference numbers and designations in the various drawings indicate like elements. For purposes of clarity, not every component can be labeled in every drawing.

FIG. 1 is a diagram of an example wireless communication system, according to an example implementation of the present disclosure.

FIG. 2 is a diagram of a console and a head wearable display for presenting augmented reality or virtual reality, according to an example implementation of the present disclosure.

FIG. 3 is a diagram of a head wearable display, according to an example implementation of the present disclosure.

FIG. 4 is a block diagram of a computing environment according to an example implementation of the present disclosure.

FIG. 5A and FIG. 5B are block diagram of use cases which may implement multi-modal signaling, according to an example implementation of the present disclosure.

FIG. 6 is a block diagram of a system for multi-modal signaling, according to an example implementation of the present disclosure.

FIG. 7 is a diagram showing a wireless communication system, according to an example implementation of the present disclosure.

FIG. 8 is a flowchart showing an example method for multi-modal signaling, according to an example implementation of the present disclosure.

### DETAILED DESCRIPTION

Before turning to the figures, which illustrate certain embodiments in detail, it should be understood that the present disclosure is not limited to the details or methodology set forth in the description or illustrated in the figures. It should also be understood that the terminology used herein is for the purpose of description only and should not be regarded as limiting.

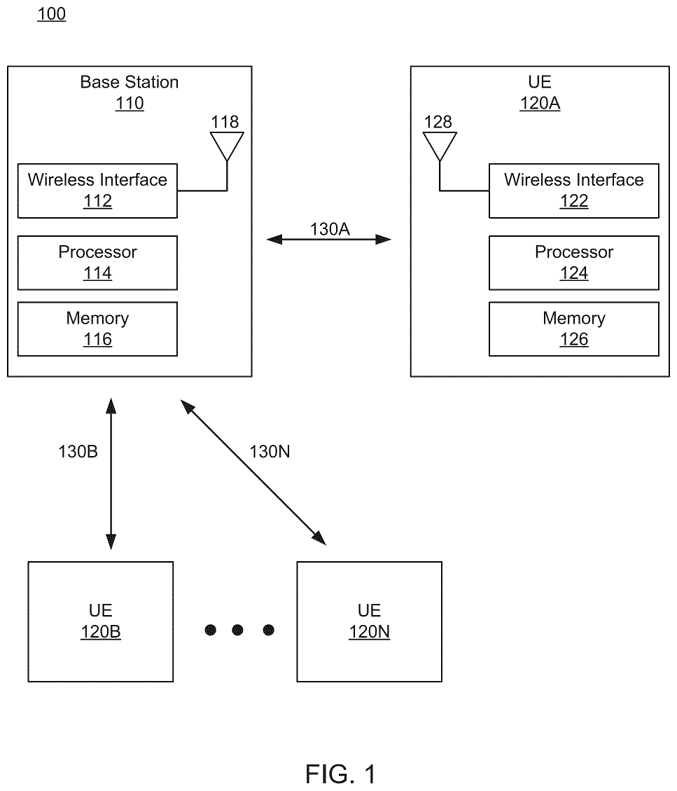

FIG. 1 illustrates an example wireless communication system 100. The wireless communication system 100 may include a base station 110 (also referred to as “a wireless communication node 110” or “a station 110”) and one or more user equipment (UEs) 120 (also referred to as “wireless communication devices 120” or “terminal devices 120”). The base station 110 and the UEs 120 may communicate through wireless commination links 130A, 130B, 130C. The wireless communication link 130 may be a cellular communication link conforming to 3G, 4G, 5G or other cellular communication protocols or a Wi-Fi communication protocol. In one example, the wireless communication link 130 supports, employs or is based on an orthogonal frequency division multiple access (OFDMA). In one aspect, the UEs 120 are located within a geographical boundary with respect to the base station 110, and may communicate with or through the base station 110. In some embodiments, the wireless communication system 100 includes more, fewer, or different components than shown in FIG. 1. For example, the wireless communication system 100 may include one or more additional base stations 110 than shown in FIG. 1.

In some embodiments, the UE 120 may be a user device such as a mobile phone, a smart phone, a personal digital assistant (PDA), tablet, laptop computer, wearable computing device, etc. Each UE 120 may communicate with the base station 110 through a corresponding communication link 130. For example, the UE 120 may transmit data to a base station 110 through a wireless communication link 130, and receive data from the base station 110 through the wireless communication link 130. Example data may include audio data, image data, text, etc. Communication or transmission of data by the UE 120 to the base station 110 may be referred to as an uplink communication. Communication or reception of data by the UE 120 from the base station 110 may be referred to as a downlink communication. In some embodiments, the UE 120A includes a wireless interface 122, a processor 124, a memory device 126, and one or more antennas 128. These components may be embodied as hardware, software, firmware, or a combination thereof. In some embodiments, the UE 120A includes more, fewer, or different components than shown in FIG. 1. For example, the UE 120 may include an electronic display and/or an input device. For example, the UE 120 may include additional antennas 128 and wireless interfaces 122 than shown in FIG. 1.

The antenna 128 may be a component that receives a radio frequency (RF) signal and/or transmit a RF signal through a wireless medium. The RF signal may be at a frequency between 200 MHz to 100 GHz. The RF signal may have packets, symbols, or frames corresponding to data for communication. The antenna 128 may be a dipole antenna, a patch antenna, a ring antenna, or any suitable antenna for wireless communication. In one aspect, a single antenna 128 is utilized for both transmitting the RF signal and receiving the RF signal. In one aspect, different antennas 128 are utilized for transmitting the RF signal and receiving the RF signal. In one aspect, multiple antennas 128 are utilized to support multiple-in, multiple-out (MIMO) communication.

The wireless interface 122 includes or is embodied as a transceiver for transmitting and receiving RF signals through a wireless medium. The wireless interface 122 may communicate with a wireless interface 112 of the base station 110 through a wireless communication link 130A. In one configuration, the wireless interface 122 is coupled to one or more antennas 128. In one aspect, the wireless interface 122 may receive the RF signal at the RF frequency received through antenna 128, and downconvert the RF signal to a baseband frequency (e.g., 0-1 GHz). The wireless interface 122 may provide the downconverted signal to the processor 124. In one aspect, the wireless interface 122 may receive a baseband signal for transmission at a baseband frequency from the processor 124, and upconvert the baseband signal to generate a RF signal. The wireless interface 122 may transmit the RF signal through the antenna 128.

The processor 124 is a component that processes data. The processor 124 may be embodied as field programmable gate array (FPGA), application specific integrated circuit (ASIC), a logic circuit, etc. The processor 124 may obtain instructions from the memory device 126, and executes the instructions. In one aspect, the processor 124 may receive downconverted data at the baseband frequency from the wireless interface 122, and decode or process the downconverted data. For example, the processor 124 may generate audio data or image data according to the downconverted data, and present an audio indicated by the audio data and/or an image indicated by the image data to a user of the UE 120A. In one aspect, the processor 124 may generate or obtain data for transmission at the baseband frequency, and encode or process the data. For example, the processor 124 may encode or process image data or audio data at the baseband frequency, and provide the encoded or processed data to the wireless interface 122 for transmission.

The memory device 126 is a component that stores data. The memory device 126 may be embodied as random access memory (RAM), flash memory, read only memory (ROM), erasable programmable read-only memory (EPROM), electrically erasable programmable read-only memory (EEPROM), registers, a hard disk, a removable disk, a CD-ROM, or any device capable for storing data. The memory device 126 may be embodied as a non-transitory computer readable medium storing instructions executable by the processor 124 to perform various functions of the UE 120A disclosed herein. In some embodiments, the memory device 126 and the processor 124 are integrated as a single component.

In some embodiments, each of the UEs 120B . . . 120N includes similar components of the UE 120A to communicate with the base station 110. Thus, detailed description of duplicated portion thereof is omitted herein for the sake of brevity.

In some embodiments, the base station 110 may be an evolved node B (eNB), a serving eNB, a target eNB, a femto station, or a pico station. The base station 110 may be communicatively coupled to another base station 110 or other communication devices through a wireless communication link and/or a wired communication link. The base station 110 may receive data (or a RF signal) in an uplink communication from a UE 120. Additionally or alternatively, the base station 110 may provide data to another UE 120, another base station, or another communication device. Hence, the base station 110 allows communication among UEs 120 associated with the base station 110, or other UEs associated with different base stations. In some embodiments, the base station 110 includes a wireless interface 112, a processor 114, a memory device 116, and one or more antennas 118. These components may be embodied as hardware, software, firmware, or a combination thereof. In some embodiments, the base station 110 includes more, fewer, or different components than shown in FIG. 1. For example, the base station 110 may include an electronic display and/or an input device. For example, the base station 110 may include additional antennas 118 and wireless interfaces 112 than shown in FIG. 1.

The antenna 118 may be a component that receives a radio frequency (RF) signal and/or transmit a RF signal through a wireless medium. The antenna 118 may be a dipole antenna, a patch antenna, a ring antenna, or any suitable antenna for wireless communication. In one aspect, a single antenna 118 is utilized for both transmitting the RF signal and receiving the RF signal. In one aspect, different antennas 118 are utilized for transmitting the RF signal and receiving the RF signal. In one aspect, multiple antennas 118 are utilized to support multiple-in, multiple-out (MIMO) communication.

The wireless interface 112 includes or is embodied as a transceiver for transmitting and receiving RF signals through a wireless medium. The wireless interface 112 may communicate with a wireless interface 122 of the UE 120 through a wireless communication link 130. In one configuration, the wireless interface 112 is coupled to one or more antennas 118. In one aspect, the wireless interface 112 may receive the RF signal at the RF frequency received through antenna 118, and downconvert the RF signal to a baseband frequency (e.g., 0-1 GHz). The wireless interface 112 may provide the downconverted signal to the processor 124. In one aspect, the wireless interface 122 may receive a baseband signal for transmission at a baseband frequency from the processor 114, and upconvert the baseband signal to generate a RF signal. The wireless interface 112 may transmit the RF signal through the antenna 118.

The processor 114 is a component that processes data. The processor 114 may be embodied as FPGA, ASIC, a logic circuit, etc. The processor 114 may obtain instructions from the memory device 116, and executes the instructions. In one aspect, the processor 114 may receive downconverted data at the baseband frequency from the wireless interface 112, and decode or process the downconverted data. For example, the processor 114 may generate audio data or image data according to the downconverted data. In one aspect, the processor 114 may generate or obtain data for transmission at the baseband frequency, and encode or process the data. For example, the processor 114 may encode or process image data or audio data at the baseband frequency, and provide the encoded or processed data to the wireless interface 112 for transmission. In one aspect, the processor 114 may set, assign, schedule, or allocate communication resources for different UEs 120. For example, the processor 114 may set different modulation schemes, time slots, channels, frequency bands, etc. for UEs 120 to avoid interference. The processor 114 may generate data (or UL CGs) indicating configuration of communication resources, and provide the data (or UL CGs) to the wireless interface 112 for transmission to the UEs 120.

The memory device 116 is a component that stores data. The memory device 116 may be embodied as RAM, flash memory, ROM, EPROM, EEPROM, registers, a hard disk, a removable disk, a CD-ROM, or any device capable for storing data. The memory device 116 may be embodied as a non-transitory computer readable medium storing instructions executable by the processor 114 to perform various functions of the base station 110 disclosed herein. In some embodiments, the memory device 116 and the processor 114 are integrated as a single component.

In some embodiments, communication between the base station 110 and the UE 120 is based on one or more layers of Open Systems Interconnection (OSI) model. The OSI model may include layers including: a physical layer, a Medium Access Control (MAC) layer, a Radio Link Control (RLC) layer, a Packet Data Convergence Protocol (PDCP) layer, a Radio Resource Control (RRC) layer, a Non Access Stratum (NAS) layer or an Internet Protocol (IP) layer, and other layer.

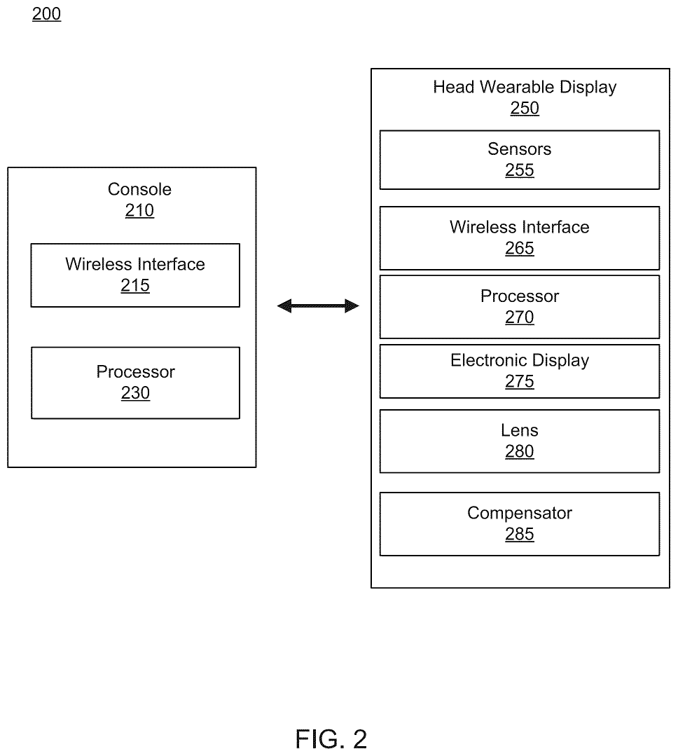

FIG. 2 is a block diagram of an example artificial reality system environment 200. In some embodiments, the artificial reality system environment 200 includes a HWD 250 worn by a user, and a console 210 providing content of artificial reality (e.g., augmented reality, virtual reality, mixed reality) to the HWD 250. Each of the HWD 250 and the console 210 may be a separate UE 120. The HWD 250 may be referred to as, include, or be part of a head mounted display (HMD), head mounted device (HMD), head wearable device (HWD), head worn display (HWD) or head worn device (HWD). The HWD 250 may detect its location and/or orientation of the HWD 250 as well as a shape, location, and/or an orientation of the body/hand/face of the user, and provide the detected location/or orientation of the HWD 250 and/or tracking information indicating the shape, location, and/or orientation of the body/hand/face to the console 210. The console 210 may generate image data indicating an image of the artificial reality according to the detected location and/or orientation of the HWD 250, the detected shape, location and/or orientation of the body/hand/face of the user, and/or a user input for the artificial reality, and transmit the image data to the HWD 250 for presentation. In some embodiments, the artificial reality system environment 200 includes more, fewer, or different components than shown in FIG. 2. In some embodiments, functionality of one or more components of the artificial reality system environment 200 can be distributed among the components in a different manner than is described here. For example, some of the functionality of the console 210 may be performed by the HWD 250. For example, some of the functionality of the HWD 250 may be performed by the console 210. In some embodiments, the console 210 is integrated as part of the HWD 250.

In some embodiments, the HWD 250 is an electronic component that can be worn by a user and can present or provide an artificial reality experience to the user. The HWD 250 may render one or more images, video, audio, or some combination thereof to provide the artificial reality experience to the user. In some embodiments, audio is presented via an external device (e.g., speakers and/or headphones) that receives audio information from the HWD 250, the console 210, or both, and presents audio based on the audio information. In some embodiments, the HWD 250 includes sensors 255, a wireless interface 265, a processor 270, an electronic display 275, a lens 280, and a compensator 285. These components may operate together to detect a location of the HWD 250 and a gaze direction of the user wearing the HWD 250, and render an image of a view within the artificial reality corresponding to the detected location and/or orientation of the HWD 250. In other embodiments, the HWD 250 includes more, fewer, or different components than shown in FIG. 2.

In some embodiments, the sensors 255 include electronic components or a combination of electronic components and software components that detect a location and an orientation of the HWD 250. Examples of the sensors 255 can include: one or more imaging sensors, one or more accelerometers, one or more gyroscopes, one or more magnetometers, or another suitable type of sensor that detects motion and/or location. For example, one or more accelerometers can measure translational movement (e.g., forward/back, up/down, left/right) and one or more gyroscopes can measure rotational movement (e.g., pitch, yaw, roll). In some embodiments, the sensors 255 detect the translational movement and the rotational movement, and determine an orientation and location of the HWD 250. In one aspect, the sensors 255 can detect the translational movement and the rotational movement with respect to a previous orientation and location of the HWD 250, and determine a new orientation and/or location of the HWD 250 by accumulating or integrating the detected translational movement and/or the rotational movement. Assuming for an example that the HWD 250 is oriented in a direction 25 degrees from a reference direction, in response to detecting that the HWD 250 has rotated 20 degrees, the sensors 255 may determine that the HWD 250 now faces or is oriented in a direction 45 degrees from the reference direction. Assuming for another example that the HWD 250 was located two feet away from a reference point in a first direction, in response to detecting that the HWD 250 has moved three feet in a second direction, the sensors 255 may determine that the HWD 250 is now located at a vector multiplication of the two feet in the first direction and the three feet in the second direction.

In some embodiments, the sensors 255 include eye trackers. The eye trackers may include electronic components or a combination of electronic components and software components that determine a gaze direction of the user of the HWD 250. In some embodiments, the HWD 250, the console 210 or a combination of them may incorporate the gaze direction of the user of the HWD 250 to generate image data for artificial reality. In some embodiments, the eye trackers include two eye trackers, where each eye tracker captures an image of a corresponding eye and determines a gaze direction of the eye. In one example, the eye tracker determines an angular rotation of the eye, a translation of the eye, a change in the torsion of the eye, and/or a change in shape of the eye, according to the captured image of the eye, and determines the relative gaze direction with respect to the HWD 250, according to the determined angular rotation, translation and the change in the torsion of the eye. In one approach, the eye tracker may shine or project a predetermined reference or structured pattern on a portion of the eye, and capture an image of the eye to analyze the pattern projected on the portion of the eye to determine a relative gaze direction of the eye with respect to the HWD 250. In some embodiments, the eye trackers incorporate the orientation of the HWD 250 and the relative gaze direction with respect to the HWD 250 to determine a gate direction of the user. Assuming for an example that the HWD 250 is oriented at a direction 30 degrees from a reference direction, and the relative gaze direction of the HWD 250 is −10 degrees (or 350 degrees) with respect to the HWD 250, the eye trackers may determine that the gaze direction of the user is 20 degrees from the reference direction. In some embodiments, a user of the HWD 250 can configure the HWD 250 (e.g., via user settings) to enable or disable the eye trackers. In some embodiments, a user of the HWD 250 is prompted to enable or disable the eye trackers.

In some embodiments, the wireless interface 265 includes an electronic component or a combination of an electronic component and a software component that communicates with the console 210. The wireless interface 265 may be or correspond to the wireless interface 122. The wireless interface 265 may communicate with a wireless interface 215 of the console 210 through a wireless communication link through the base station 110. Through the communication link, the wireless interface 265 may transmit to the console 210 data indicating the determined location and/or orientation of the HWD 250, and/or the determined gaze direction of the user. Moreover, through the communication link, the wireless interface 265 may receive from the console 210 image data indicating or corresponding to an image to be rendered and additional data associated with the image.

In some embodiments, the processor 270 includes an electronic component or a combination of an electronic component and a software component that generates one or more images for display, for example, according to a change in view of the space of the artificial reality. In some embodiments, the processor 270 is implemented as a part of the processor 124 or is communicatively coupled to the processor 124. In some embodiments, the processor 270 is implemented as a processor (or a graphical processing unit (GPU)) that executes instructions to perform various functions described herein. The processor 270 may receive, through the wireless interface 265, image data describing an image of artificial reality to be rendered and additional data associated with the image, and render the image to display through the electronic display 275. In some embodiments, the image data from the console 210 may be encoded, and the processor 270 may decode the image data to render the image. In some embodiments, the processor 270 receives, from the console 210 in additional data, object information indicating virtual objects in the artificial reality space and depth information indicating depth (or distances from the HWD 250) of the virtual objects. In one aspect, according to the image of the artificial reality, object information, depth information from the console 210, and/or updated sensor measurements from the sensors 255, the processor 270 may perform shading, reprojection, and/or blending to update the image of the artificial reality to correspond to the updated location and/or orientation of the HWD 250. Assuming that a user rotated his head after the initial sensor measurements, rather than recreating the entire image responsive to the updated sensor measurements, the processor 270 may generate a small portion (e.g., 10%) of an image corresponding to an updated view within the artificial reality according to the updated sensor measurements, and append the portion to the image in the image data from the console 210 through reprojection. The processor 270 may perform shading and/or blending on the appended edges. Hence, without recreating the image of the artificial reality according to the updated sensor measurements, the processor 270 can generate the image of the artificial reality.

In some embodiments, the electronic display 275 is an electronic component that displays an image. The electronic display 275 may, for example, be a liquid crystal display or an organic light emitting diode display. The electronic display 275 may be a transparent display that allows the user to see through. In some embodiments, when the HWD 250 is worn by a user, the electronic display 275 is located proximate (e.g., less than 3 inches) to the user's eyes. In one aspect, the electronic display 275 emits or projects light towards the user's eyes according to image generated by the processor 270.

In some embodiments, the lens 280 is a mechanical component that alters received light from the electronic display 275. The lens 280 may magnify the light from the electronic display 275, and correct for optical error associated with the light. The lens 280 may be a Fresnel lens, a convex lens, a concave lens, a filter, or any suitable optical component that alters the light from the electronic display 275. Through the lens 280, light from the electronic display 275 can reach the pupils, such that the user can see the image displayed by the electronic display 275, despite the close proximity of the electronic display 275 to the eyes.

In some embodiments, the compensator 285 includes an electronic component or a combination of an electronic component and a software component that performs compensation to compensate for any distortions or aberrations. In one aspect, the lens 280 introduces optical aberrations such as a chromatic aberration, a pin-cushion distortion, barrel distortion, etc. The compensator 285 may determine a compensation (e.g., predistortion) to apply to the image to be rendered from the processor 270 to compensate for the distortions caused by the lens 280, and apply the determined compensation to the image from the processor 270. The compensator 285 may provide the predistorted image to the electronic display 275.

In some embodiments, the console 210 is an electronic component or a combination of an electronic component and a software component that provides content to be rendered to the HWD 250. In one aspect, the console 210 includes a wireless interface 215 and a processor 230. These components may operate together to determine a view (e.g., a FOV of the user) of the artificial reality corresponding to the location of the HWD 250 and the gaze direction of the user of the HWD 250, and can generate image data indicating an image of the artificial reality corresponding to the determined view. In addition, these components may operate together to generate additional data associated with the image. Additional data may be information associated with presenting or rendering the artificial reality other than the image of the artificial reality. Examples of additional data include, hand model data, mapping information for translating a location and an orientation of the HWD 250 in a physical space into a virtual space (or simultaneous localization and mapping (SLAM) data), eye tracking data, motion vector information, depth information, edge information, object information, etc. The console 210 may provide the image data and the additional data to the HWD 250 for presentation of the artificial reality. In other embodiments, the console 210 includes more, fewer, or different components than shown in FIG. 2. In some embodiments, the console 210 is integrated as part of the HWD 250.

In some embodiments, the wireless interface 215 is an electronic component or a combination of an electronic component and a software component that communicates with the HWD 250. The wireless interface 215 may be or correspond to the wireless interface 122. The wireless interface 215 may be a counterpart component to the wireless interface 265 to communicate through a communication link (e.g., wireless communication link). Through the communication link, the wireless interface 215 may receive from the HWD 250 data indicating the determined location and/or orientation of the HWD 250, and/or the determined gaze direction of the user. Moreover, through the communication link, the wireless interface 215 may transmit to the HWD 250 image data describing an image to be rendered and additional data associated with the image of the artificial reality.

The processor 230 can include or correspond to a component that generates content to be rendered according to the location and/or orientation of the HWD 250. In some embodiments, the processor 230 is implemented as a part of the processor 124 or is communicatively coupled to the processor 124. In some embodiments, the processor 230 may incorporate the gaze direction of the user of the HWD 250. In one aspect, the processor 230 determines a view of the artificial reality according to the location and/or orientation of the HWD 250. For example, the processor 230 maps the location of the HWD 250 in a physical space to a location within an artificial reality space, and determines a view of the artificial reality space along a direction corresponding to the mapped orientation from the mapped location in the artificial reality space. The processor 230 may generate image data describing an image of the determined view of the artificial reality space, and transmit the image data to the HWD 250 through the wireless interface 215. In some embodiments, the processor 230 may generate additional data including motion vector information, depth information, edge information, object information, hand model data, etc., associated with the image, and transmit the additional data together with the image data to the HWD 250 through the wireless interface 215. The processor 230 may encode the image data describing the image, and can transmit the encoded data to the HWD 250. In some embodiments, the processor 230 generates and provides the image data to the HWD 250 periodically (e.g., every 11 ms).

In one aspect, the process of detecting the location of the HWD 250 and the gaze direction of the user wearing the HWD 250, and rendering the image to the user should be performed within a frame time (e.g., 11 ms or 16 ms). A latency between a movement of the user wearing the HWD 250 and an image displayed corresponding to the user movement can cause judder, which may result in motion sickness and can degrade the user experience. In one aspect, the HWD 250 and the console 210 can prioritize communication for AR/VR, such that the latency between the movement of the user wearing the HWD 250 and the image displayed corresponding to the user movement can be presented within the frame time (e.g., 11 ms or 16 ms) to provide a seamless experience.

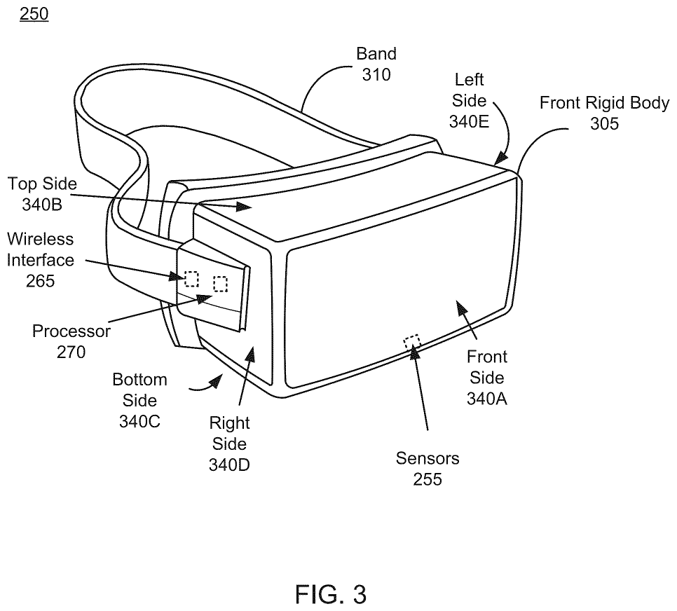

FIG. 3 is a diagram of a HWD 250, in accordance with an example embodiment. In some embodiments, the HWD 250 includes a front rigid body 305 and a band 310. The front rigid body 305 includes the electronic display 275 (not shown in FIG. 3), the lens 280 (not shown in FIG. 3), the sensors 255, the wireless interface 265, and the processor 270. In the embodiment shown by FIG. 3, the wireless interface 265, the processor 270, and the sensors 255 are located within the front rigid body 205, and may not be visible externally. In other embodiments, the HWD 250 has a different configuration than shown in FIG. 3. For example, the wireless interface 265, the processor 270, and/or the sensors 255 may be in different locations than shown in FIG. 3.

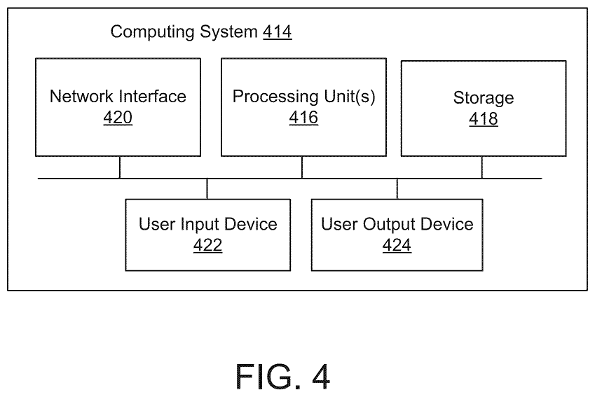

Various operations described herein can be implemented on computer systems. FIG. 4 shows a block diagram of a representative computing system 414 usable to implement the present disclosure. In some embodiments, the source devices 110, the sink device 120, the console 210, the HWD 250 are implemented by the computing system 414. Computing system 414 can be implemented, for example, as a consumer device such as a smartphone, other mobile phone, tablet computer, wearable computing device (e.g., smart watch, eyeglasses, head wearable display), desktop computer, laptop computer, or implemented with distributed computing devices. The computing system 414 can be implemented to provide VR, AR, MR experience. In some embodiments, the computing system 414 can include conventional computer components such as processors 416, storage device 418, network interface 420, user input device 422, and user output device 424.

Network interface 420 can provide a connection to a wide area network (e.g., the Internet) to which WAN interface of a remote server system is also connected. Network interface 420 can include a wired interface (e.g., Ethernet) and/or a wireless interface implementing various RF data communication standards such as Wi-Fi, Bluetooth, or cellular data network standards (e.g., 3G, 4G, 5G, 60 GHz, LTE, etc.).

The network interface 420 may include a transceiver to allow the computing system 414 to transmit and receive data from a remote device using a transmitter and receiver. The transceiver may be configured to support transmission/reception supporting industry standards that enables bi-directional communication. An antenna may be attached to transceiver housing and electrically coupled to the transceiver. Additionally or alternatively, a multi-antenna array may be electrically coupled to the transceiver such that a plurality of beams pointing in distinct directions may facilitate in transmitting and/or receiving data.

A transmitter may be configured to wirelessly transmit frames, slots, or symbols generated by the processor unit 416. Similarly, a receiver may be configured to receive frames, slots or symbols and the processor unit 416 may be configured to process the frames. For example, the processor unit 416 can be configured to determine a type of frame and to process the frame and/or fields of the frame accordingly.

User input device 422 can include any device (or devices) via which a user can provide signals to computing system 414; computing system 414 can interpret the signals as indicative of particular user requests or information. User input device 422 can include any or all of a keyboard, touch pad, touch screen, mouse or other pointing device, scroll wheel, click wheel, dial, button, switch, keypad, microphone, sensors (e.g., a motion sensor, an eye tracking sensor, etc.), and so on.

User output device 424 can include any device via which computing system 414 can provide information to a user. For example, user output device 424 can include a display to display images generated by or delivered to computing system 414. The display can incorporate various image generation technologies, e.g., a liquid crystal display (LCD), light-emitting diode (LED) including organic light-emitting diodes (OLED), projection system, cathode ray tube (CRT), or the like, together with supporting electronics (e.g., digital-to-analog or analog-to-digital converters, signal processors, or the like). A device such as a touchscreen that function as both input and output device can be used. Output devices 424 can be provided in addition to or instead of a display. Examples include indicator lights, speakers, tactile “display” devices, printers, and so on.

Some implementations include electronic components, such as microprocessors, storage and memory that store computer program instructions in a computer readable storage medium (e.g., non-transitory computer readable medium). Many of the features described in this specification can be implemented as processes that are specified as a set of program instructions encoded on a computer readable storage medium. When these program instructions are executed by one or more processors, they cause the processors to perform various operation indicated in the program instructions. Examples of program instructions or computer code include machine code, such as is produced by a compiler, and files including higher-level code that are executed by a computer, an electronic component, or a microprocessor using an interpreter. Through suitable programming, processor 416 can provide various functionality for computing system 414, including any of the functionality described herein as being performed by a server or client, or other functionality associated with message management services.

It will be appreciated that computing system 414 is illustrative and that variations and modifications are possible. Computer systems used in connection with the present disclosure can have other capabilities not specifically described here. Further, while computing system 414 is described with reference to particular blocks, it is to be understood that these blocks are defined for convenience of description and are not intended to imply a particular physical arrangement of component parts. For instance, different blocks can be located in the same facility, in the same server rack, or on the same motherboard. Further, the blocks need not correspond to physically distinct components. Blocks can be configured to perform various operations, e.g., by programming a processor or providing appropriate control circuitry, and various blocks might or might not be reconfigurable depending on how the initial configuration is obtained. Implementations of the present disclosure can be realized in a variety of apparatus including electronic devices implemented using any combination of circuitry and software.

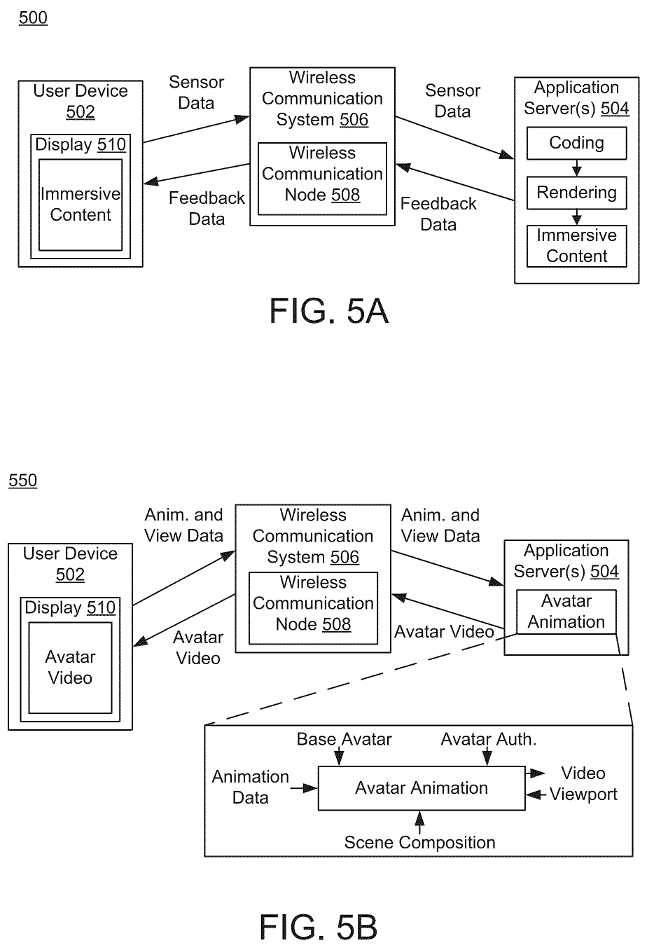

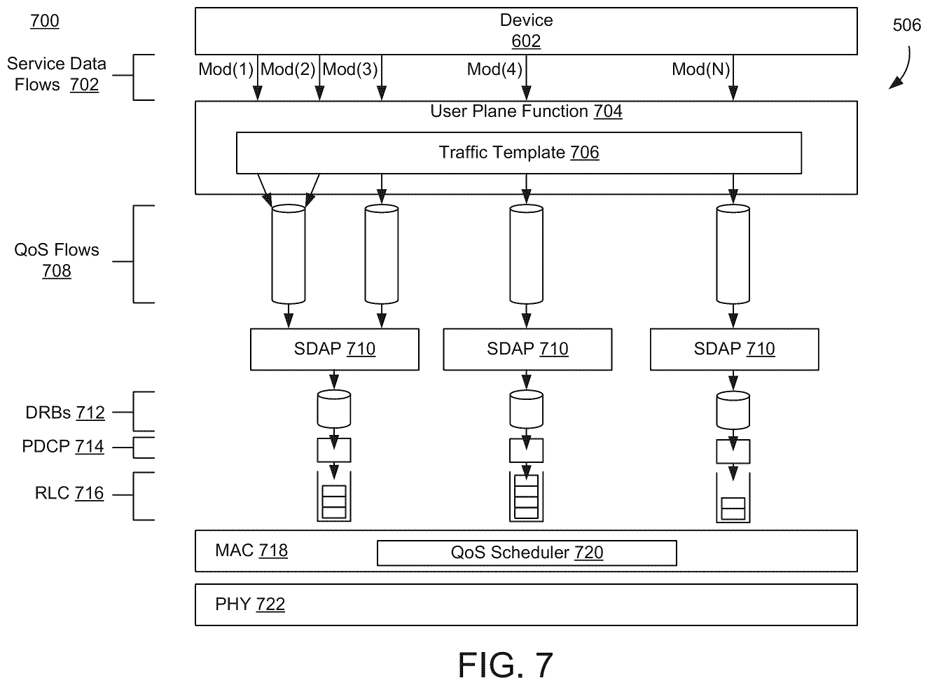

Referring now to FIG. 5A and FIG. 5B, depicted are block diagrams of use cases which may implement multi-modal signaling, according to an example implementation of the present disclosure. Specifically, FIG. 5A shows an example system 500 which may be used for interactive gaming or other immersive content delivery to a user device 502. FIG. 5B shows an example system 550 which may be used for an avatar-based communication session. In both example systems 500, 550, the systems 500, 550 may include a user device 502 communicably coupled with an application server 504 via a wireless communication system 506. The user device 502 may be similar to the user equipment 120, console 210, and/or head wearable display 250 described above with reference to FIG. 1-FIG. 4. The wireless communication system 506 may include various wireless communication node(s) 508, which may include the base station 110 described above with reference to FIG. 1, or one or more of the components described below in FIG. 7. The application server 504 may be or include any server which hosts, provisions, provides, supports, or is otherwise associated with one or more applications executable on the user device 502. In the example shown in FIG. 5A, the application server 504 may be associated with an immersive content application (e.g., an interactive gaming, virtual reality environment, etc.). In the example shown in FIG. 5B, the application server 504 may be associated with an avatar-based communication application (e.g., a video call or conferencing application which supports avatar-based communication).

In each of the example systems 500, 550, communication between the source devices (e.g., the user device 502, application server 504, and/or another user device or endpoint) may include or involve multi-modal signaling. For example, multi-modal signaling may include different types of data/information corresponding to respective modalities (e.g., voice data, video data, audio data, sensor data, viewport data, control data, file transfer protocol (FTP) data, and so forth).

Beginning with FIG. 5A, in the context of an immersive content application, a user device 502 may be configured to communicate (e.g., via the wireless communication data) sensor data to the application server 504. The sensor data may be sensed, measured, collected, or otherwise detected by the user device 502 (or another user device communicably coupled with the user device 502). The sensor data may be indicative of real-time positions/movement/gestures/other user inputs to the user device 502. The application server 504 may be configured to code or otherwise translate the sensor data into updated renderings of the immersive content, which is provided (e.g., as feedback data) via the wireless communication system 506 back to the user device 502 for display via a display 510. As the user moves (e.g., in the physical environment), such movements may be captured as sensor data, which is again sent via the wireless communication system 506 to the application server 504 to update renderings and, correspondingly, the immersive content, which is provided as feedback data to the user device 502 (e.g., until the end-user terminates the immersive content application).

In FIG. 5B, in the context of an avatar-based communication application, the user device 502 may be configured to communicate animation data and viewport data via the wireless communication system 506 to the application server 504. The animation data may include data which is extracted/determined by the user device 502 based on sensor data (e.g., movement data, facial expression data, etc.). The viewport data may be directional data which is determined based on sensor data (e.g., movement of the user's head or eyes indicative of a change in viewport). Additionally, additional data may be provided, such as audio or voice data (e.g., sensed user speech), video data of the user's surroundings, and so forth. The application server may include an avatar animation system which generates scene composition based on the video data, configures an avatar for the user based on the animation data and an avatar request indicating various modifications to a base avatar according to an avatar authorization, and outputs video data based on the configured avatar, the scene composition, and the viewport. The application server may transmit (e.g., via the wireless communication system 506) the avatar video back to the user device 502 for rendering via a display 510. Like the immersive content application described above with reference to FIG. 5A, as the user speaks, changes position or facial expressions, the user device 502 may be configured to generate updated animation and viewport data, which is processed by the application server 504 for generating the avatar video, which is then sent back to the user device 502 for display (e.g., until the end-user terminates the avatar-based communication application).

In each of these example systems 500, 550 (and other example applications or systems), the communication between source and receiver devices (e.g., user device 502, application server 504, and other user devices) may include or involve multi-modal traffic or flows. Some implementations relating to extended reality (XR) may involve or relate to enhancements of single-modal XR traffic. Synchronized and coordinated transmission of multi-modal flows may be an important aspect to ensure satisfactory end-to-end quality of service (QoS) and user experience. Multi-modal flows may take diverse forms and the traffic characteristics may change dynamically, as illustrated in FIG. 5A and FIG. 5B. Some multi-modal flows may have their individual performance and QoS requirements, in terms of data rate, latency and reliability. From an XR application perspective, meeting single-modal QoS requirement may not translate to achieving good end-to-end performance.

According to the systems and methods described herein, multi-modal signaling may be introduced and designed to enhance the synchronization and coordination of multi-modal flows. When Service Data Flows (SDFs) are mapped into QoS flows, intra-SDF inter-QoS flow coordination information may be generated as part of additional 5QI attributes. For example, coordination information may include inter-SDF or inter-QoS flow dependency (e.g., dependency: Dep_0, Dep_1, etc.), relative reliability or importance (relative reliability/importance: Rel_error_level_0, Rel_error_level_1, etc.), and/or relative timing or latency (relative timing/latency: Rel_delay_level_0, Rel_delay_level_1, etc.). Such implementations may signal to the wireless communication system 506, correspondence between flows, which the wireless communication system 506 can use for scheduling packet/information/data delivery to an endpoint in coordinated fashion, thereby achieving strong end-to-end performance.

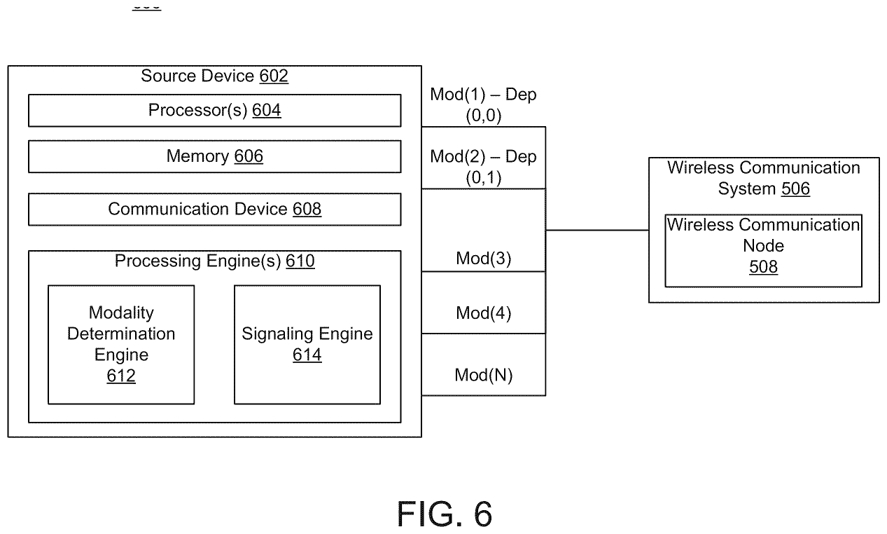

Referring now to FIG. 6, depicted is a block diagram of a system 600 for multi-modal signaling, according to an example implementation of the present disclosure. The system 600 may include a source device 602 communicably coupled to the wireless communication system 506. The source device 602 may one or more processors 604, memory 606, and a communication device 608. While shown as included on the source device 602, in various embodiments, the wireless communication system 506 (including the components/elements/wireless communication nodes 508 thereof) may similarly include processor(s), memory, and a communication device. The processor(s) 604 may be the same as or similar to the processors 114, 124, 230, 270 and/or processing unit(s) 416 described above with reference to FIG. 1-FIG. 4. The memory 606 may be the same as or similar to memory 116, 126, and/or storage 418 described above with reference to FIG. 1-FIG. 4. The communication device 608 may be the same as or similar to the wireless interface 112, 122, 215, 265 (e.g., in combination with or communicably coupled to antenna 118, 128) and/or network interface 420 described above with reference to FIG. 1-FIG. 4.

The source device 602 may include one or more processing engines 610. The processing engine(s) 610 may be or include any device, component, element, or hardware designed or configured to perform one or more of the functions described herein. The processing engine(s) 610 may include a modality determination engine 612 and a signaling engine 614. While these processing engine(s) 610 are shown and described herein, it should be understood that additional and/or alternative processing engine(s) 610 may be implemented on the application server 504. Additionally, two or more of the processing engine(s) 610 may be implemented as a single processing engine 610. Furthermore, one of the processing engine(s) 610 may implemented as multiple processing engines 610. Additionally, while shown as included on the source device 602, it is noted that the source device 602 (e.g., a user device 502, application server 504) and/or wireless communication node(s) 508 of the wireless communication system 506 may include, implement, or otherwise incorporate processing engines 610 in addition to the source device 602.

The modality determination engine 612 may be designed or configured to detect, identify, select, configure, or otherwise determine modalities which are to be supported by/used with/associated with a session corresponding to the source device 602. The modalities that may be determined by the modality determination engine 612 may include, but are not limited to, audio, video, voice, sensor, control, and file transfer protocol (FTP). The audio modality may carry sound data, such as music or sound effects, that can be transmitted or received during a session. The video modality may carry visual data, such as live video streams or pre-recorded video content. The voice modality may carry speech data, which may be used for communication or voice command recognition. The sensor modality may carry data generated by sensors, such as accelerometers, gyroscopes, pose or positioning sensors, viewport sensors, eye tracking sensors, or other sensors, which may provide context or feedback for applications that may be supported by the session. The control modality may carry signals or commands for controlling devices or systems, such as remote control commands for a connected appliance. The FTP modality may carry file data, enabling the transfer of digital files between devices during a session. Various combinations of these modalities (and additional/alternative modalities) may be used or supported by a given session, depending on the application(s) which are running/supported by/executed on the source device 602. In the example shown in FIG. 6, the modality determination engine 612 may be configured to determine or otherwise identify N modalities (e.g., Mod(1), Mod(2), Mod(3), Mod(4), and Mod(N)). While, in FIG. 6, the N number modalities is shown as 5, it should be understood that any number of modalities may be identified/determined by the modality determination engine 612.

In some embodiments, the modality determination engine 612 may be configured to determine modalities based on or according to the application which is executing on/running on/supported by the source device 602. In some embodiments, the modality determination engine 612 may be configured to determine modalities based on input parameters, such as user preferences, application support configurations, network conditions, and/or device capabilities. For example, where the modality determination engine 612 determines modalities based on user preferences, the modality determination engine 612 may be configured to determine a modality for audio-only, communication if the user selects a low-bandwidth mode. As another example, where the modality determination engine 612 determines modalities based on application support configurations, the modality determination engine 612 may be configured to determine a modalities for both video and haptic feedback for an application that supports immersive interactions. As yet another example, where the modality determination engine 612 determines modalities based on network conditions, the modality determination engine 612 may be configured to determine a modality of audio communication and disable high-resolution video if the available bandwidth is constrained. As still another example, where the modality determination engine 612 determines modalities based on device capabilities, the modality determination engine 612 may be configured to determine a modality of haptic feedback in instances where the source device 602 includes a vibration mechanism capable of supporting such functionality.

In some embodiments, the modality determination engine 612 may be configured to determine the type of content which is being generated and/or received by an application, such as audio, video, voice, or sensor data, and determine the corresponding modalities which are to be used for generating and/or receiving the types of content. For example, each application may include configuration data or information indicating the types of modalities to be used for generating and/or receiving specific types of content. The configuration data may specify, for instance, that a video conferencing application utilizes audio, voice, and video modalities, while a fitness tracking application uses sensor data and haptic feedback modalities.

The modality determination engine 612 may be configured to configure, establish, or otherwise generate one or more tags indicating association between two or more modalities of the multi-modal flow. The tags may include, indicate, or otherwise identify dependency between two or more modalities, relative reliability or importance of the modalities, relative timing or urgency of the modalities, and so forth. In some embodiments, the modality determination engine 612 may be configured to determine or otherwise identify the association between the modalities based on or according to the modalities determined or identified by the modality determination engine 612. For example, the modality determination engine 612 may be configured to determine associations between two or more modalities by analyzing metadata, application-layer signaling, or contextual information provided by the source device 602 or the application executing on the source device 602. For instance, the application may include descriptors or identifiers indicating that certain modalities, such as video and audio, are part of the same media stream or session. In some embodiments, the modality determination engine 612 may be configured to use session identifiers, timestamps, or synchronization markers embedded in the data streams to recognize that the modalities are temporally and contextually linked. In some embodiments, the modality determination engine 612 may reference pre-configured profiles or application-specific information that define associations between modalities for specific use cases, such as linking voice and control data in a voice-command application.

The signaling engine 614 may be configured to establish a connection with the wireless communication system 506 to support communication with another endpoint (such as the application server 504 or another user device 502), including communication of traffic corresponding to the N modalities. In some embodiments, the signaling engine 614 may be configured to perform an initial access procedure (e.g., a random access (RA) procedure) according to various network configurations or protocols (e.g., by transmitting a RA request, receiving a RA response, etc. with a base station corresponding to the wireless communication system 506).

The signaling engine 614 may be configured to generate, communicate, send, or otherwise transmit one or more signals to indicate the modalities which are to be used for the session between the source device 602 and another device (e.g., the application server 504 or user device 502). In some embodiments, the signal(s) may include, for instance, radio resource control (RRC) message(s), non-access stratum (NAS) message(s) which include one or more fields that signal, indicate, or otherwise identify the modalities (Mod(1)-Mod(N)) to the wireless communication system 506 (e.g., to the wireless communication node 508 of the wireless communication system 506).

In some embodiments, the signal(s) may include, identify, or otherwise indicate the tag(s) which identify the association between two or more of the respective modalities. For example, as shown in FIG. 6, the signal(s) may include a first and second tag, indicating a dependency between the first modality Mod(1) and the second modality Mod(2). In this example, the dependency indicate that the first and second modalities Mod(1), Mod(2) are associated with (e.g., depend from) one another. For instance, the first modality Mod(1) may be or include an audio modality, and the second modality Mod(2) may be or include a video modality. While described as dependencies, in various embodiments, additional tags or indicators may be configured/generated which indicate other associations/relative quality of service (QoS) metrics between modalities. For example, the signaling engine 614 may be configured to signal tags/indicators indicating a relative reliability or importance between two or more modalities (e.g., relative error level—rel_error_level_0, rel_error_level_1, etc.). As another example, the signaling engine 614 may be configured to signal tags/indicators indicating a relative timing or latency between two or more modalities (e.g., relative delay level—rel_delay_level_0, rel_delay_level_1, etc.).

Referring to FIG. 7, with continued reference to FIG. 6, FIG. 7 is a diagram showing the wireless communication system 506 in greater detail, according to an example implementation of the present disclosure. As shown in FIG. 7, each modality Mod may be mapped to or otherwise correspond with a respective service data flow (SDF) 702. In other words, a particular modality (e.g., Mod(1), Mod(2) . . . Mod(N)) may have a corresponding SDF 702 (e.g., an SDF for Mod(1), an SDF for Mod(2), and so forth). For example, traffic (e.g., data, packets, information) which corresponds to a respective modality (e.g., Mod(1)) may be represented by a respective SDF 702, representing the flow of traffic corresponding to the modality within the network.

As shown in FIG. 7, the wireless communication system 506 may include a user plane function (UPF) 704 which translates, configures, or otherwise maps SDFs 702 to a respective quality of service (QoS) flow 708. In some embodiments, the UPF 704 may map the SDFs 702 to a respective QoS flow 708 using a traffic template 706. The traffic template 706 may be or include a predefined or dynamically generated set of rules or parameters that specify/define/configure how SDFs 702 corresponding to respective modalities are to be mapped to QoS flows 708. In some embodiments, the UPF 704 may be configured to map the SDFs 702 to a corresponding QoS flow 708, based on or according to a respective 5G QoS Identifier (5QI) values associated with the QoS flows 708 and the corresponding tags received from the signaling engine 614. For example, each 5QI value may define specific QoS parameters, such as latency budget, packet error rate, and priority, which may be used to ensure that the modalities are handled according to their requirements. In some embodiments, the traffic template 706 (or templates) may include various criteria for mapping SDFs 702 to QoS flows 708, such as but not limited to IP addresses, port numbers, protocol types, or application identifiers that define the characteristics of the SDFs. For example, the traffic template 706 may specify that an SDF 702 for audio data packets from a video conferencing application are mapped to a QoS flow 708 with low latency and high reliability, while an SDF 702 for file transfer packets are mapped to a QoS flow 708 with higher throughput but reduced latency requirements. In this example, the QoS flows 708 would be associated with 5QI values, such as a lower 5QI value for the audio data to ensure low latency and high reliability, and greater 5QI value for the file transfer to prioritize high throughput.

In some embodiments, the UPF 704 may be configured to use, define, or otherwise configure the traffic template 706 based on or according to the tags sent/signaled by the device 602 (e.g., by the signaling engine 614). For example, and as shown in FIG. 7, the UPF 704 may be configured to map the SDF 702 corresponding to the first modality Mod(1) and the SDF 702 corresponding to the second modality Mod(2) to the first QoS flow 708 (e.g., while other SDFs 702 corresponding to the other modalities may be mapped to other QoS flows). In this example, the first modality Mod(1) may be or include audio data, the second modality Mod(2) may be or include video data, and the third modality Mod(3) may be or include control data which is used to decode and process the video and audio data. The tags sent/signaled by the device 602 may further include or reference 5QI values for the respective QoS flows, to configure/establish/provide that the audio and video flows are aligned with reduced 5QI values. Similarly, tags may indicate that the control flow, while still associated with the audio and video modalities, may have a greater 5QI value (e.g., than that of the audio and video flows), reflecting its ability to tolerate slightly higher latency while maintaining sufficient reliability. The tags sent/signaled by the device 602 may indicate that the first, second, and third modalities Mod(1), Mod(2), Mod(3) are related/dependent from one another, and that the QoS requirements of the first and second modalities Mod(1), Mod(2) are related to one another, based on the particular use case as determined by the modality determination engine 612. In this regard, the UPF 704 may be configured to receive the tags signaled by the device 602, and map the corresponding SDFs 702 to a corresponding QoS flow 708.

As one example, the signaling engine 614 may be configured to signal tags that indicate an association between three modalities, such as audio, video, and control modalities, which are both part of the same video conferencing session. For instance, the tags may be or include Dep (0, 0), and Dep (0, 1), indicating a common dependency between the modalities, thereby indicating the SDFs 702 corresponding to the audio and video modalities are to be delivered in synchronization to ensure a coherent user experience. Furthermore, the tags may indicate that the control modality includes control data which is to be used to decode and synchronize the audio and video data streams. Upon receiving the signaling, the UPF 704 may be configured to use the traffic template 706 to classify the incoming SDFs 702 corresponding to the audio and video modalities. Because the tags indicate that the modalities are dependent, the traffic template 706 may be configured to map both the audio and video SDFs 702 to a same (e.g., a common) QoS flow 708, which is configured to provide low latency and high reliability. However, the UPF 704 may be configured to map the SDF 702 corresponding to the control modality to a different QoS flow 708. For example, while the control modality may be signaled as being associated with the audio and video modalities, the tags may indicate a relative latency of the audio and video modalities as being more stringent than that of the control modality. Thus, the UPF 704 may be configured to map the SDF 702 corresponding to the control data to a different QoS flow 708 with slightly less stringent latency requirements, as the control data may tolerate minor delays without significantly impacting synchronization.

As another example, the signaling engine 614 may be configured to signals tags that indicate an association between various modalities, such as voice, animation signaling, and background audio or video modalities, in the context of an avatar-based communication application. The tags may specify that voice and animation signaling modalities are dependent from one another and have the highest relative priority for latency and reliability, as the traffic of the SDFs 702 facilitate real-time communication and ensure that the avatar's movements and expressions are synchronized with the user's speech. In contrast, other modalities, such as background environmental effects (e.g., ambient audio or background video), may be less critical and may tolerate higher latency or lower reliability without significantly impacting the session. The UPF 704 may be configured to map the various SDFs 702 corresponding to the modalities to a respective QoS flow 708. For example, the UPF 704 may be configured to map the voice and animation signaling SDFs 702 to a QoS flow 708 configured with stringent latency and reliability parameters, and map the SDF(s) 702 corresponding to background effects (e.g., ambient audio modality and/or video modality) to a separate QoS flow 708 optimized for high throughput or resource efficiency.

Following the UPF 704 mapping the respective SDFs 702 to corresponding QoS flows 708, the traffic carried by the SDFs 702 may be delivered through the wireless communication network 506 to the endpoint. Each QoS flow 708 may be passed from the UPF 704 to the Service Data Adaptation Protocol (SDAP) layer 710, where the QoS flows 708 are mapped to one or more Data Radio Bearers (DRBs) 712. The SDAP 710 may be configured to tag packets of the SDFs 702 with the appropriate QoS identifiers, to facilitate maintenance of the QoS requirements as the packets progresses through the protocol stack.

In some embodiments, two (or more) QoS flows 708 may share a (e.g., single, common) SDAP 710, as shown in FIG. 7, when their respective data streams (e.g., corresponding to different modalities) are part of the same logical Data Radio Bearer (DRB) 712. Continuing the example described above involving audio, video, and control modalities, the SDFs 702 corresponding to the audio and video modalities may be mapped to a single QoS flow because they share common QoS requirements (e.g., low latency and high reliability). However, the SDF 702 corresponding to the control modality may be mapped to a separate QoS flow with slightly reduced latency requirements (relative to the audio and video SDFs 702). Despite having distinct QoS flows, the SDFs 702 corresponding to the audio, video, and control modalities may share the same SDAP 710 if they are associated with the same DRB 712. For example, the SDFs 702 may share the same DRB 712 for resource utilization efficiency, simplification of packet tagging and processing, etc.

At the DRB 712 level, the data packets (e.g., from each SDF 702) may be encapsulated for transmission over the air interface, and passed to the Packet Data Convergence Protocol (PDCP) layer 714. The PDCP 714 may be configured to perform header compression, encryption, and reordering of packets (e.g., to ensure data integrity and efficient use of the wireless resources). The PDCP 714 may be configured to pass the compressed, encrypted, and reordered packets to the Radio Link Control (RLC) layer 716. At the RLC 716 layer, the packets may be further segmented and adapted according to channel conditions. Following RLC 716 processing, the data packets may be passed to the Medium Access Control (MAC) layer 718, which may be configured to implement resource allocation and scheduling of the packets to an endpoint. The MAC layer 718 may include a QoS scheduler 720 which allocates radio resources according to the QoS requirements of each DRB 712. The QoS scheduler 720 may be configured to prioritize data transmission of certain packets, based on factors such as latency sensitivity, reliability needs, and channel conditions. For instance, a DRB 712 supporting a low-latency voice QoS flow 708 may receive higher priority for transmission as compared to a DRB 712 supporting a non-critical background data flow. The MAC layer 718 may be configured to pass packets to the physical (PHY) layer 722, where the packets are modulated, encoded, and transmitted as radio waves to the endpoint.

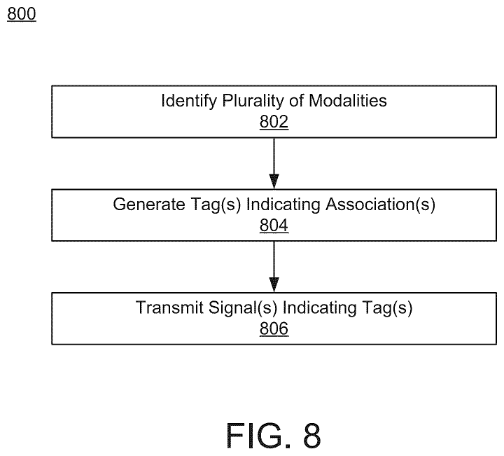

Referring now to FIG. 8, depicted is a flowchart showing an example method 800 for multi-modal signaling, according to an example implementation of the present disclosure. The method 800 may be performed, executed, or otherwise implemented by the devices, components, elements, or hardware described above with reference to FIG. 1-FIG. 7. As a brief overview, at step 802, a device may identify a plurality of modalities. At step 804, the device may generate one or more tags indicating one or more associations. At step 806, the device may transmit one or more signals indicating the tag(s).

At step 802, a device may identify a plurality of modalities. In some embodiments, a first device may identify the plurality of modalities. The first device may be or include a source device, such as the user device 502 and/or application server 504 described above. In some embodiments, the first device may identify the plurality of modalities relating to respective traffic types of a multi-modal flow of an application. The first device may identify the plurality of modalities for traffic of the application, which is to be sent to a second device.

In some embodiments, the first device may identify the plurality of modalities responsive to launching an application which is to communicate traffic via a wireless communication system (e.g., via a network, such as a cellular network). For example, the first device may identify the modalities when an end user selects a user interface element or other input to trigger launching of the application on the first device (or another device communicably coupled to the first device). In some embodiments, the first device may identify the plurality of modalities responsive to receiving a request (e.g., from the application layer of the first device) to establish the connection for communicating the traffic to a second device. For example, the first device may identify the modalities when an end user selects a user interface element or other input to trigger initiating a communication session with the second device (e.g., entering an online mode, initiating a voice/video/audio call, requesting immersive content, and so forth).

In some embodiments, the first device may identify the plurality of modalities based on the application executing on the first device. For example, the first device may analyze configuration or metadata associated with the application, to determine the types of data streams or interactions which are to be used for the session. For instance, the first device may determine/identify/detect the input and output data types the application supports, the resources consumed by the application, and the user preferences associated with its operation. Various examples of modalities may include, but are not limited to, an audio modality, a video modality, a voice modality, a sensor modality, a control modality, and/or a file transfer protocol (FTP) modality. For instance, a video conferencing application may use an audio modality for voice communication, a video modality for transmitting camera data, and a control modality for synchronizing the audio and video streams. Similarly, a fitness tracking application may use a sensor modality to collect data from wearable devices and an FTP modality to upload the collected data to a cloud server.

At step 804, the device may generate one or more tags indicating one or more associations. In some embodiments, the device may generate one or more tags for service data flows (SDFs) corresponding to the respective modalities. The device may generate the one or more tags, to indicate an association between respective modalities. For example, and in some embodiments, the device may generate a first tag for a first SDF corresponding to a first modality, and a second tag for a second SDF corresponding to a second modality, where the first tag and the second tag indicates an association between the first SDF and the second SDF within the multi-modal flow. To continue this example, the device may generate the tags to indicate an association between various SDFs, based on dependency/QoS metrics, and so forth of the respective modalities.

In some implementations, in the case of a video conferencing application, the device may generate tags for video, audio, and control modalities. The first tag, corresponding to the video modality, and the second tag, corresponding to the audio modality, may indicate a dependency between these two modalities. The dependency may indicate that their respective SDFs are to be synchronized and delivered with low latency, to maintain a seamless user experience. A third tag, corresponding to the control modality, may further indicate that the control data is associated with the video and audio modalities, to be used for decoding and synchronizing the respective streams. While the video and audio SDFs may be mapped to the same QoS flow (e.g., due to their similar low-latency and high-reliability requirements), the control SDF may be mapped to a separate QoS flow with reduced latency constraints (e.g., relative to that of the QoS flow to which the video and audio SDFs are mapped).

At step 806, the device may transmit one or more signals indicating the tag(s). In some embodiments, the first device may transmit the one or more signals indicating the tag(s) to a wireless communication node. In some embodiments, the device may transmit the signal(s) as part of connection establishment or maintenance. For example, the device may transmit the signal(s) to establish the connection for transmitting traffic between the device and another device. In various implementations of this example, the signal(s) may be separate from traffic which is sent between the devices/endpoints, but may be exchanged as part of connection setup. As another example, the device may transmit the signal(s) as part of connection maintenance. For instance, the device may transmit the signal(s) with packets including the traffic (e.g., as part of exchanging traffic between the device and another device). In these and other various embodiments, the first device may transmit the signal(s) indicating various tags, for transmission of traffic between the device and another device (e.g., as part of connection setup/establishment and/or connection maintenance or use).

In some embodiments, the first device may generate and apply a first tag to a first portion of traffic associated with a first modality, such as audio data, and a second tag to a second portion of traffic associated with a second modality, such as video data, where both portions of traffic are carried over the same QoS flow. In other words, and in some embodiments, the device may transmit the tags appended to the traffic itself, which is sent between the source and receiver devices. The tags (e.g., applied to the traffic) may facilitate a user plane function (UPF) or other function/layer of the wireless communication network, to distinguish between traffic associated with the respective modalities even when transmitted on the same QoS flow. In some embodiments, the device may separately transmit the tags indicating the association between the first and second modalities (e.g., independent of the traffic itself). For example, the device may transmit a signaling message containing the tags (e.g., metadata or descriptors) that indicate the association between the audio and video modalities, including their relative QoS metrics and dependencies. In this example, the wireless communication system may implement preemptive network resource allocation and coordination.

In some embodiments, transmission of the tag(s) causes the wireless communication node to coordinate respective portions of traffic of the SDFs, for transmission to the second device, according to the tags. For example, in the context of a video conferencing application, the device may generate tags for audio, video, and control modalities. The first tag, associated with the audio SDF, and the second tag, associated with the video SDF, may indicate that these modalities are dependent and are to be synchronized for seamless playback. A third tag, associated with the control SDF, may indicate that the control traffic is to be used to manage and synchronize the audio and video streams but does not need the same strict latency as the audio and video streams. Upon receiving these tags, the wireless communication node (e.g., the base station or UPF) may coordinate the respective portions of traffic from the SDFs based on the tags. For instance, the wireless communication node may prioritize the transmission of audio and video packets, ensuring low latency and high reliability, while scheduling the control packets on with slightly relaxed latency constraints. For example, the wireless communication node may map the corresponding SDFs to respective QoS flows, such as mapping the SDFs corresponding to audio and video traffic to a QoS flow with stringent latency and reliability requirements, and mapping the SDF corresponding to the control traffic to a different QoS flow with relaxed latency requirements.

Having now described some illustrative implementations, it is apparent that the foregoing is illustrative and not limiting, having been presented by way of example. In particular, although many of the examples presented herein involve specific combinations of method acts or system elements, those acts and those elements can be combined in other ways to accomplish the same objectives. Acts, elements and features discussed in connection with one implementation are not intended to be excluded from a similar role in other implementations or implementations.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device, etc.) may include one or more devices (e.g., RAM, ROM, Flash memory, hard disk storage, etc.) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit and/or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular can also embrace implementations including a plurality of these elements, and any references in plural to any implementation or element or act herein can also embrace implementations including only a single element. References in the singular or plural form are not intended to limit the presently disclosed systems or methods, their components, acts, or elements to single or plural configurations. References to any act or element being based on any information, act or element can include implementations where the act or element is based at least in part on any information, act, or element.

Any implementation disclosed herein can be combined with any other implementation or embodiment, and references to “an implementation,” “some implementations,” “one implementation” or the like are not necessarily mutually exclusive and are intended to indicate that a particular feature, structure, or characteristic described in connection with the implementation can be included in at least one implementation or embodiment. Such terms as used herein are not necessarily all referring to the same implementation. Any implementation can be combined with any other implementation, inclusively or exclusively, in any manner consistent with the aspects and implementations disclosed herein.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Systems and methods described herein may be embodied in other specific forms without departing from the characteristics thereof. References to “approximately,” “about” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

The term “coupled” and variations thereof includes the joining of two members directly or indirectly to one another. Such joining may be stationary (e.g., permanent or fixed) or moveable (e.g., removable or releasable). Such joining may be achieved with the two members coupled directly with or to each other, with the two members coupled with each other using a separate intervening member and any additional intermediate members coupled with one another, or with the two members coupled with each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References to “or” can be construed as inclusive so that any terms described using “or” can indicate any of a single, more than one, and all of the described terms. A reference to “at least one of ‘A’ and ‘B’” can include only ‘A’, only ‘B’, as well as both ‘A’ and ‘B’. Such references used in conjunction with “comprising” or other open terminology can include additional items.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

References herein to the positions of elements (e.g., “top,” “bottom,” “above,” “below”) are merely used to describe the orientation of various elements in the FIGURES. The orientation of various elements may differ according to other exemplary embodiments, and that such variations are intended to be encompassed by the present disclosure.

1. A method, comprising:
identifying, by a first device, a plurality of modalities relating to respective traffic types of a multi-modal flow of an application, for traffic of the application to be sent to a second device;
generating, by the first device, a first tag for a first service data flow (SDF) for a first modality and a second tag for a second SDF for a second modality, the first tag and the second tag indicating an association between the first SDF and the second SDF within the multi-modal flow; and
transmitting, by the first device to a wireless communication node, one or more signals indicating the first tag and the second tag, for transmission of the traffic between the first device and the second device.

2. The method of claim 1, wherein the plurality of modalities comprises at least one of an audio modality, a video modality, a voice modality, a sensor modality, a control modality, or a file transfer protocol (FTP) modality.

3. The method of claim 1, wherein each modality of the plurality of modalities is associated with a respective SDF, and each SDF is mapped to a respective quality of service (QoS) flow.

4. The method of claim 3, wherein the first SDF is mapped to a first QoS flow, and the second SDF is mapped to the first QoS flow.

5. The method of claim 4, wherein the first tag is applied to a first portion of the traffic associated with the first modality on the first QoS flow, and the second tag is applied to a second portion of the traffic associated with the second modality on the first QoS flow.

6. The method of claim 4, wherein a third SDF for a third modality of the plurality of modalities is mapped to a second QoS flow.

7. The method of claim 1, wherein the first device identifies the plurality of modalities based on the application executing on the first device.

8. The method of claim 1, wherein transmitting the first tag and the second tag, causes the wireless communication node to coordinate a first portion of the traffic corresponding to the first SDF and a second portion of the traffic corresponding to the second SDF, for transmission to the second device, according to the first tag and the second tag.

9. The method of claim 1, further comprising generating, by the first device, for each modality of the plurality of modalities, a respective indicator indicating a relative quality of service (QoS) metric for the modality relative to other of the plurality of modalities.

10. A first device, comprising:
one or more processors configured to:
identify a plurality of modalities relating to respective traffic types of a multi-modal flow of an application, for traffic of the application to be sent to a second device;
generate a first tag for a first service data flow (SDF) for a first modality and a second tag for a second SDF for a second modality, the first tag and the second tag indicating an association between the first SDF and the second SDF within the multi-modal flow; and
transmit, via a transmitter to a wireless communication node, one or more signals indicating the first tag and the second tag, for transmission of the traffic between the first device and the second device.

11. The first device of claim 10, wherein the plurality of modalities comprises at least one of an audio modality, a video modality, a voice modality, a sensor modality, a control modality, or a file transfer protocol (FTP) modality.

12. The first device of claim 10, wherein each modality of the plurality of modalities is associated with a respective SDF, and wherein each SDF is mapped to a respective quality of service (QoS) flow.

13. The first device of claim 12, wherein the first SDF is mapped to a first QoS flow, and the second SDF is mapped to the first QoS flow.

14. The first device of claim 13, wherein the first tag is applied to a first portion of the traffic associated with the first modality on the first QoS flow, and the second tag is applied to a second portion of the traffic associated with the second modality on the first QoS flow.

15. The first device of claim 13, wherein a third SDF for a third modality of the plurality of modalities is mapped to a second QoS flow.

16. The first device of claim 10, wherein the first device identifies the plurality of modalities based on the application executing on the first device.

17. The first device of claim 10, wherein transmission of the first tag and the second tag, causes the wireless communication node to coordinate a first portion of the traffic corresponding to the first SDF and a second portion of traffic corresponding to the second SDF, for transmission to the second device, according to the first tag and the second tag.

18. The first device of claim 10, wherein the one or more processors are configured to generate, for each modality of the plurality of modalities, a respective indicator indicating a relative quality of service (QoS) metric for the modality relative to other of the plurality of modalities.

19. A non-transitory computer readable medium storing instructions that, when executed by one or more processors, cause the one or more processors to:
identify a plurality of modalities relating to respective traffic types of a multi-modal flow of an application, for traffic of the application to be sent to a second device;
generate a first tag for a first service data flow (SDF) for a first modality and a second tag for a second SDF for a second modality, the first tag and the second tag indicating an association between the first SDF and the second SDF within the multi-modal flow; and
transmit, via a transmitter to a wireless communication node, one or more signals indicating the first tag and the second tag, for transmission of the traffic between the first device and the second device.

20. The non-transitory computer readable medium of claim 19, wherein:
each modality of the plurality of modalities is associated with a respective SDF, and wherein each SDF is mapped to a respective quality of service (QoS) flow, including the first SDF and the second SDF being mapped to a first QoS flow, and a third modality being mapped to a second QoS flow.
